(19) United States
(12) Patent Application Publication
(10) Pub. No.: US 2015/0077843 A1
(43) Pub. Date: Mar. 19, 2015

(54) HIGH-RESOLUTION SCANNING MICROSCOPY

(71) Applicant: Carl Zeiss Microscopy GmbH, Jena (DE)

(72) Inventor: Dieter HUHSE, Berlin (DE)

(21) Appl. No.: 14/489,738

(22) Filed: Sep. 18, 2014

Related U.S. Application Data
(60) Provisional application No. 62/025,667, filed on Jul. 17, 2014.

(30) Foreign Application Priority Data
Sep. 19, 2013 (DE) DE102013015932.6

(51) Int. Cl. G02B 21/00; G02B 21/02

(52) U.S. Cl. CPC G02B 21/0072; G02B 21/008; G02B 21/025; G02B 6/065
USPC 359/380; 359/385

(57) ABSTRACT

A microscope and method for high resolution scanning microscopy of a sample, having: an illumination device for the purpose of illuminating the sample, an imaging device for the purpose of scanning at least one point or linear spot over the sample and of imaging the point or linear spot into a diffraction-limited, static single image below an imaging scale in a detection plane. A detector device is used for the purpose of detecting the single image in the detection plane for various scan positions, with a location accuracy which, taking into account the imaging scale in at least one dimension/measurement, is at least twice as high as a full width at half maximum of the diffraction-limited single image. A non-imaging redistribution element is arranged in front of a detector array of the detector and which distributes the radiation from the detection plane onto the pixels of the detector array in a non-imaging manner, and the redistribution element comprises a bundle of optical fibers.

### RELATED APPLICATIONS

The present application is a nonprovisional of provisional patent application Ser. No. 62/025,667 filed on Jul. 17, 2014 and claims priority benefit of German Application No. DE 10 2013 015 932.6 filed on Sep. 19, 2013, the contents of each are incorporated by reference in their entirety.

### FIELD OF THE INVENTION

The invention relates to a microscope for high resolution scanning microscopy of a sample. The microscope has an illumination device for the purpose of illuminating the sample, an imaging device for the purpose of scanning a point or linear spot across the sample and of imaging the point or linear spot into a diffraction-limited, static single image, with an imaging scale in a detection plane, a detector device for the purpose of detecting the single image in the detection plane for various scan positions with a location accuracy (or spatial resolution) that, taking into account the imaging scale, is at least twice as high as a full width at half maximum of the diffraction-limited single image. The microscope also has an evaluation device for the purpose of evaluating a diffraction structure of the single image for the scan positions, using data from the detector device, and for the purpose of generating an image of the sample that has a resolution which is enhanced beyond the diffraction limit. The invention further relates to a method for high resolution scanning microscopy of a sample. The method includes steps for illuminating a sample, and imaging a point or linear spot guided over the sample in a scanning manner into a single image. The spot is imaged into the single image, with an imaging scale, and diffraction-limited, while the single image is static in a detection plane. The single image is detected for various scan positions with a location accuracy that is at least twice as high, taking into account the imaging scale, as a full width at half maximum of the diffraction-limited single image, so that a diffraction structure of the single image is detected. For each scan position, the diffraction structure of the single image is evaluated and an image of the sample is generated which has a resolution that is enhanced beyond the diffraction limit.

### BACKGROUND OF THE INVENTION

Such a microscope and/or microscopy method is known from, by way of example, the publication C. Müller and J. Enderlein, Physical Review Letters, 104, 198101 (2010), or EP 2317362 A1, which also lists further aspects of the prior art.

This approach achieves an increase in location accuracy by imaging a spot on a detection plane in a diffraction-limited manner. The diffraction-limited imaging process images a point spot as an Airy disk. This diffraction spot is detected in the detection plane in such a manner that its structure can be resolved. Consequently, an oversampling is realized at the detector with respect to the imaging power of the microscope. The shape of the Airy disk is resolved in the imaging of a point spot. With a suitable evaluation of the diffraction structure—which is detailed in the documents named (the disclosure of which in this regard is hereby cited in its entirety in this application) an increase in resolution by a factor of 2 beyond the diffraction limit is achieved.

However, it is unavoidable in this case of the detector, that it is necessary to capture a single image with multiple times more image information for each point on the sample that is scanned in this way, compared to a conventional laser scanning microscope (shortened to “LSM” below). If the structure of the single image of the spot is detected, by way of example, with 16 pixels, not only is the volume of data per spot 16 times higher, but also a single pixel contains, on average, only 1/16 of the radiation intensity which would fall on the detector of an LSM in conventional pinhole detection. Because the radiation intensity is, of course, not evenly distributed across the structure of the single image—for example the Airy disk—in reality, even less—and particularly significantly less—radiation intensity arrives at the edge of this structure than the average value of 1/n for n pixels.

Consequently, the problem exists of being able to detect quantities of radiation at the detector at high resolution. Conventional CCD arrays that are typically used in microscopy do not achieve sufficient signal-to-noise ratios, such that even a prolongation of the duration for the image capture, which would already be disadvantageous in application per se, would not provide further assistance. APD arrays also suffer from excessively high dark noise, such that a prolongation of the measurement duration would result here as well in an insufficient signal/noise ratio. The same is true for CMOS detectors, which are also disadvantageous with respect to the size of the detector element because the diffraction-limited single image of the spot would fall on too few pixels. PMT arrays suffer from similar constructed space problems. The pixels in this case are likewise too large. The constructed space problems are particularly a result of the fact that an implementation of a microscope for high resolution can only be realized, as far as the effort required for development and the distribution of the device are concerned, if it is possible to integrate the same into existing LSM constructions. However, specific sizes of the single images are pre-specified in this case. As a result, a detector with a larger surface area could only be installed if a lens were additionally configured that would enlarge the image once more to a significant degree—i.e. several orders of magnitude. Such a lens is very complicated to design in cases where one wishes to obtain the diffraction-limited structure without further imaging errors.

Other methods are known in the prior art for high resolution which avoid the problems listed above that occur during detection. By way of example, a method is mentioned in EP 1157297 B1, whereby non-linear processes are exploited using structured illumination. A structured illumination is positioned over the sample in multiple rotary and point positions, and the sample is imaged on a wide-field detector in these different states in which the limitations listed above are not present.

A method which also achieves high resolution without the detector limitations listed above (i.e. a resolution of a sample image beyond the diffraction limit) is known from WO 2006127692 and DE 102006021317. This method, abbreviated as PALM, uses a marking substance which can be activated by means of an optical excitation signal. Only in the activated state can the marking substance be stimulated to release certain fluorescence radiation by means of excitation light. Molecules which are not activated do not emit fluorescent radiation, even after illumination with excitation light. The excitation light therefore switches the activation substance into a state in which it can be stimulated to fluoresce. Therefore, this is generally termed a switching signal. The same is then applied in such a manner that at least a certain fraction of the activated marking molecules are spaced apart from neighboring similarly-activated marking molecules in such a manner that the activated marking molecules are separated on the scale of the optical resolution of the microscope, or may be separated subsequently. This is termed isolation of the activated molecules. It is simple, in the case of these isolated molecules, to determine the center of their radiation distribution which is limited by the resolution, and therefore to calculate the location of the molecules with a higher precision than the optical imaging actually allows. To image the entire sample, the PALM method takes advantage of the fact that the probability of a marking molecule being activated by the switching signal at a given intensity of the switching signal is the same for all of the marking molecules. The intensity of the switching signal is therefore applied in such a manner that the desired isolation results. This method step is repeated until the greatest possible number of marking molecules have been excited [at least] one time within a fraction that has been excited to fluorescence.

### SUMMARY OF THE INVENTION

In the invention, the spot sampled on the sample is imaged statically in a detection plane. The radiation from the detection plane is then redistributed in a non-imaging manner and directed to the detector array. The term “non-imaging” in this case refers to the single image present in the detection plane. However, individual regions of the area of this single image may, of course, be imaged within the laws of optics. As such, imaging lenses may naturally be placed between the detector array and the redistribution element. The single image in the detection plane, however, is not preserved as such in the redistribution.

The term “diffraction-limited” should not be restricted here to the diffraction limit according to Abbe's Theory. Rather, it should also encompass situations in which the configuration fails to reach the theoretical maximum by an error of 20% due to actual insufficiencies or limitations. In this case as well, the single image has a structure which is termed a diffraction structure in this context. It is oversampled.

This principle makes it possible to use a detector array which does not match the single image in size. The detector array is advantageously larger or smaller in one dimension than the single image being detected. The concept of the different geometric configuration includes both a different elongation of the detector array and an arrangement with a different aspect ratio with respect to the height and width of the elongation of the single image in the detection plane. The pixels of the detector array may, in addition, be too large for the required resolution. It is also allowable, at this point, for the outline of the pixel arrangement of the detector array to be fundamentally different from the outline that the single image has in the detection plane. In any event, the detector array according to the invention has a different size than the single image in the detection plane. The redistribution in the method and/or the redistribution element in the microscope make it possible to select a detector array without needing to take into account the dimensional limitations and pixel size limitations that arise as a result of the single image and its size. In particular, it is possible to use a detector row as a detector array.

In the conventional LSM manner, the image of the sample is created from multiple single images by scanning the sample with the spot, whereby each of the single images is associated with another sampling position—i.e. another scan position.

The concept of the invention may also be implemented at the same time for multiple spots in a parallel manner, as is known for laser scanning microscopy. In this case, multiple spots are sampled on the sample in a scanning manner, and the single images of the multiple spots lie next to one another statically in the detection plane. They are then either redistributed by a shared redistribution element that is accordingly large with respect to surface area, and/or by multiple individual redistribution elements, and then relayed to an accordingly large single detector array and/or to multiple individual detector arrays.

The subsequent description focuses, by way of example, on the sampling process using an individual point spot. However, this should not be understood to be a limitation, and the described features and principles apply in the same manner to the parallel sampling of multiple point spots as to the use of a linear spot. The latter case is of course only diffraction-limited in the direction perpendicular to the elongation of the line, so that the features of this description with respect to this aspect only apply in one direction (perpendicular to the elongation of the line).

With the procedure according to the invention, the LSM method may be carried out at a satisfactory speed and with acceptable complexity of the apparatus.

The invention opens up a wide field of applications for a high resolution microscopy principle that has not existed to date.

One possibility for effecting the redistribution and/or the redistribution element comprises using a bundle of optical fibers. These may preferably be designed as multi-mode optical fibers. The bundle has an input that is arranged in the detection plane and that has an adequate dimensioning for the dimensions of the diffraction-limited single image in the detection plane. In contrast, at the output, the optical fibers are arranged in the geometric arrangement that is pre-specified by the detector array and that differs from the input. The output ends of the optical fibers in this case may be guided directly to the pixels of the detector array. It is particularly advantageous if the output of the bundle is gathered in a plug that may be easily plugged into a detector row—for example, an APD or PMT row.

It is important for the understanding of the invention to differentiate between pixels of the detector array and the image pixels with which the single image is resolved in the detection plane. Each image pixel is generally precisely functionally assigned to one pixel of the detector array. However, the two are different with respect to their arrangement. Among other things, it is a characterizing feature of the invention that, in the detection plane, the radiation is captured on image pixels, which produce an oversampling of the single image with respect to their size and arrangement. In this manner, the structure of the single image is resolved that is a diffraction structure due to the diffraction-limited production of the single image. The redistribution element has an input side on which this image pixel is provided. The input side lies in the detection plane. The redistribution element directs the radiation on each image pixel to one of the pixels of the detector array. The assignment of image pixels to pixels of the detector array does not preserve the image structure, which is why the redistribution is non-imaging with respect to the single image. The invention could therefore also be characterized in that, in a generic microscope, the detector device has a non-imaging redistribution element which has input sides in the detection plane in which the radiation is captured by means of image pixels. The redistribution element, further, has an output side via which the radiation captured at the image pixels is relayed to pixels of a detector array, whereby the radiation is redistributed from the input side to the output side in a non-imaging manner with respect to the single image. In an analogous manner, the method according to the invention could be characterized in that, in a generic method, the radiation is captured in the detection plane by means of image pixels that are redistributed to pixels of the detector array in a non-imaging manner with respect to the single image. The detector array differs from the arrangement and/or the size of the image pixels in the detection plane with respect to the arrangement and/or size of its pixels. In addition, the image pixels in the detection plane are provided by the redistribution element in such a way that, with respect to the diffraction limit, the diffraction structure of the single image is oversampled.

In highly-sensitive detector arrays, it is known that adjacent pixels demonstrate interference when radiation intensities are high as a result of crosstalk. To prevent this, an implementation is preferred where the optical fibers are guided from the input to the output in such a way that optical fibers that are adjacent at the output are also adjacent at the input. Because the diffraction-limited single image does not demonstrate any large jumps in radiation intensity changes, such a configuration of the redistribution element automatically ensures that adjacent pixels of the detector array receive the least possible differences in radiation intensity, which minimizes crosstalk.

In place of a redistribution based on optical fibers, it is also possible to equip the redistribution element with a mirror that has mirror elements with different inclinations. Such a mirror may be designed, by way of example, as a multi-facet mirror, a DMD, or adaptive mirror, whereby in the latter two variants a corresponding adjustment and/or control process ensures the inclination of the mirror elements. The mirror elements direct the radiation from the detection plane to the pixels of the detector array, the geometrical design of which is different from the mirror elements.

The mirror elements depict, as do the optical fiber ends at the input of the optical fiber bundle, the image pixels with respect to the resolution of the diffraction structure of the single image. Their size is decisive for the oversampling. The pixel size of the detector array is not (is no longer). As a result, a group of multiple single detectors is understood in this case to be a detector array, because they always have a different arrangement (i.e. a larger arrangement) than the image pixels in the detection plane.

In LSM, different lenses are used depending on the desired resolution. Changing a lens changes the dimensions of a single image in the detection plane. For this reason, it is preferred that a zoom lens is arranged in front of the detection plane in the direction of imaging for the purpose of matching the size of the single image to the size of the detector device. Such a zoom lens varies the size of the single image in a percent range which is significantly smaller than 100%, and is therefore much simpler to implement than a multiplication of the size of the single image, which was described as disadvantageous above.

The illumination of the sample is preferably carried out in a scanning fashion as in a typical LSM process, although this is not absolutely necessary. However, the maximum increase in resolution is achieved in this way. If the sample is illuminated in a scanning manner, it is advantageous that the illumination device and the imaging device have a shared scanning device which guides an illumination spot across the sample and simultaneously de-scans the spot at which the sample is imaged and which is coincident with the illumination spot with respect to the detector so that the single image is static in the detection plane. In such a construction, the zoom lens may be placed in the shared part of the illumination device and imaging device. The lens then makes it possible not only to match the single image to the size of the detector in the detection plane, but also additionally enables the available illumination radiation to be coupled into the objective aperture completely, without edge loss, whereby the said objective aperture may vary together with the selection of the lens.

A radiation intensity-dependent crosstalk between adjacent pixels of the detector array may, as already explained, be reduced during the redistribution by means of an optical fiber bundle by a suitable arrangement of the optical fibers in the bundle.

In addition, or alternatively thereto, it is also possible to carry out a calibration. For this purpose, each optical fiber receives radiation one after the other, and the interference signal is detected in neighboring pixels. In this manner, a calibration matrix is established, by means of which a radiation intensity-dependent crosstalk between adjacent pixels is corrected in the later microscopy of the sample.

The resolution of the diffraction structure of the single image also makes it possible to determine a direction of movement of the spot along which it is displaced during sampling of the sample. This direction of movement is known in principle from the mechanism of the scanner (for example, a scanning mirror or a moving sample table), but nevertheless there are residual inaccuracies arising from the mechanism in this case. These may be eliminated by evaluating signals of individual pixels of the detector array by means of cross-correlation. In this case, one takes advantage of the fact that adjacent image pixels in the sample overlap to a certain extent due to the diffraction-limited imaging of the spot, whereas their centers lie adjacent to each other. If the signals of such image pixels are subjected to a cross-correlation, it is possible to reduce and/or to completely eliminate a residual inaccuracy which persists as a result of unavoidable tolerances of the scanning mechanism.

In addition to the increased resolution, it is possible to detect a chronological change in the fluorescence in the detection volume comprised by the spot via the spatial and chronological correlation of the signals from a series of measurements of the individual detector elements (to which the image pixels in the detection plane are functionally assigned). By way of example, diffusion coefficients may be determined from a chronological correlation, as in fluorescence correlation spectroscopy, and oriented diffusion and diffusion barriers may be visualized by incorporating the spatial correlation between image pixels. Movement processes of the fluorescence molecules are also of great interest for tracking applications, because the illumination spot in this case should follow the movement of the fluorescent molecules. The arrangement described here makes it possible to determine the movement direction with high precision, even during the bleaching time of a pixel. For this reason, it is preferred, as one implementation, that changes in the sample are detected by determining and evaluating a chronological change in the diffraction-limited single image for the point or linear spot that is stationary in the sample.

The procedure according to the invention also makes it possible to modify the illumination distribution in scanning illumination processes—for example by means of a phase filter. The method as described in Gong et al., Opt. Let., 34, 3508 (2009) may be realized very easily as a result.

Where a method is described herein, a control device implements this method in the operation of the microscope.

It should be understood that the features named above and explained further below may be used not only in the given combinations, but also in other combinations or alone without departing from the scope of the present invention.

### BRIEF DESCRIPTION OF THE DRAWINGS

The invention is described in greater detail below with reference to the attached drawings, which also disclose essential features of the invention, wherein:

FIG. 1 shows a schematic illustration of a laser scanning microscope for high resolution microscopy;

FIG. 2 shows an enlarged illustration of a detector device of the microscope in FIG. 1;

FIG. 3 and FIG. 4 show top views of possible embodiments of the detector device 19 in a detection plane;

FIG. 5 shows an implementation of the microscope in FIG. 1 using a zoom lens for the purpose of adapting the size of the detector field;

FIG. 6 shows a modification of the microscope in FIG. 5 with respect to the zoom lens and with respect to a further implementation for multi-color imaging;

FIG. 7 shows a modification of the microscope in FIG. 1, whereby the modification pertains to the detector device;

FIG. 8 shows a modification of the detector device 19 in FIG. 7;

FIG. 9 shows a distribution of fiber input faces;

FIG. 10 shows light funnels arranged in the direction of light upstream of the fiber input faces;

FIG. 11 shows the fiber arranged upstream of a mounted glass block with a lens array;

FIG. 12 is a view similar to FIG. 11 showing chamfered light surface;

FIG. 13 shows each individual fiber enlarged in an intermediate image plane; and

FIG. 14 shows the principle of an assignment of the areas which deviates from the regular square array.

### DETAILED DESCRIPTION OF THE DRAWINGS

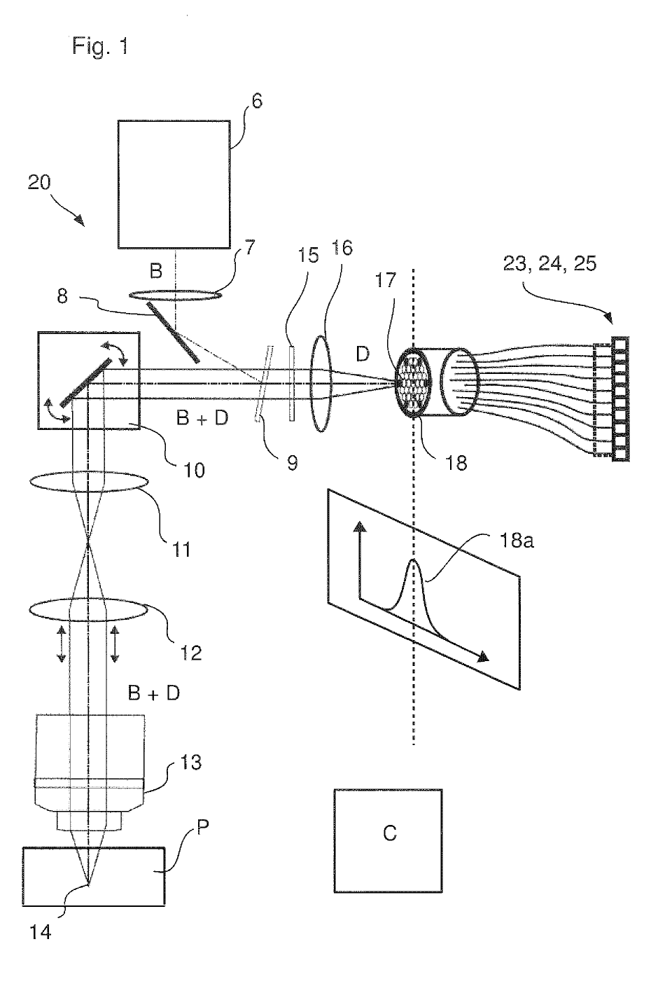

FIG. 1 schematically shows a laser scanning microscope 1 that is designed for the purpose of microscopy of a sample 2. The laser scanning microscope (abbreviated below as LSM) 1 is controlled by a control device C and comprises an illumination beam path 3 and an imaging beam path 4. The illumination beam path illuminates a spot in the sample 2, and the imaging beam path 4 images this spot, subject to the diffraction limit, for the purpose of detection. The illumination beam path 3 and the imaging beam path 4 share multiple elements. However, this is likewise less necessary than a scanned spot illumination of the sample 2. The same could also be illuminated in wide-field.

The illumination of the sample 2 in the LSM 1 is carried out by means of a laser beam 5 that is coupled into a mirror 8 via a deflection mirror 6 that is not specifically functionally necessary, and a lens 7. The mirror 8 functions so that the laser beam 5 falls on an emission filter 9 at a reflection angle. To simplify the illustration, only the primary axis of the laser beam 5 is drawn.

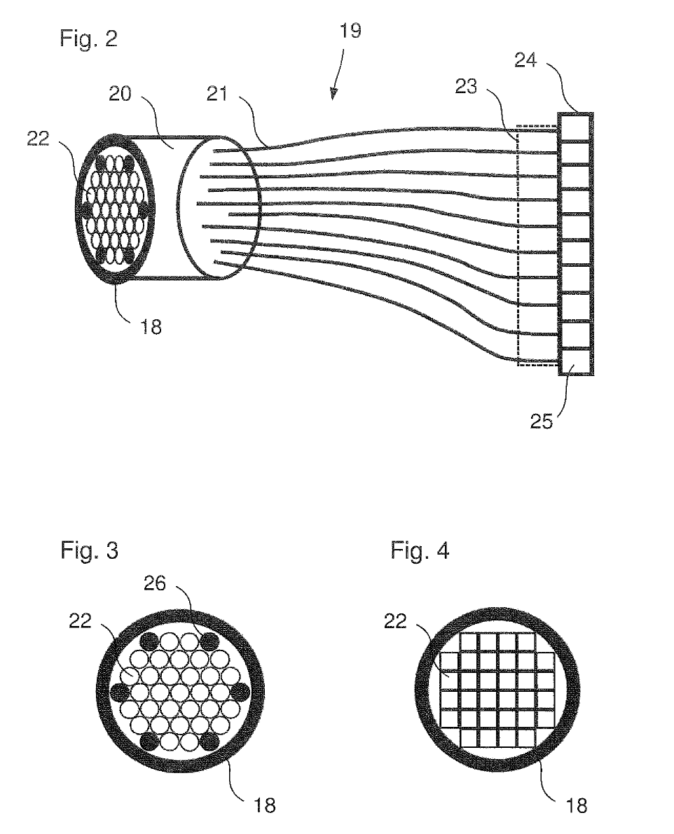

Following the reflection on the emission filter 9, the laser beam 5 is deflected biaxially by a scanner 10, and focused by means of lenses 11 and 12 through an objective lens 13 to a spot 14 in the sample 2. The spot in this case is point-shaped in the illustration in FIG. 1, but a linear spot is also possible. Fluorescence radiation excited in the spot 14 is routed via the objective lens 13, the lenses 11 and 12, and back to the scanner 10, after which a static light beam once more is present in the imaging direction. This passes through the emission filters 9 and 15, which have the function of selecting the fluorescence radiation in the spot 14, with respect to the wavelength thereof, and particularly of separating the same from the illumination radiation of the laser beam 5, which may serve as excitation radiation, by way of example. A lens 16 functions so that the spot 14 overall is imaged into a diffraction-limited image 17 which lies in a detection plane 18. The detection plane 18 is a plane which is conjugate to the plane in which the spot 14 in the sample 2 lies. The image 17 of the spot 14 is captured in the detection plane 18 by a detector device 19 which is explained in greater detail below in the context of FIGS. 2 to 4. In this case, it is essential that the detector device 19 spatially resolves the diffraction-limited image 17 of the spot 14 in the detection plane 18.

The intensity distribution of the spot over the detection cross-section (the Gaussian distribution) in 18 is illustrated below as 18a in FIG. 1.

The control device C controls all components of the LSM 1, particularly the scanner 10 and the detector device 19. The control device captures the data of each individual image 17 for different scan positions, analyzes the diffraction structure thereof, and generates a high resolution composite image of the sample 2.

The LSM 1 in FIG. 1 is illustrated by way of example for a single spot that is scanned on the sample. However, it may also be used for the purpose of scanning according to a linear spot that extends, by way of example, perpendicularly to the plane of the drawing in FIG. 1. It is also possible to design the LSM 1 in FIG. 1 in such a manner that multiple adjacent point spots in the sample are scanned. As a result, their corresponding single images 17 lie in the detection plane 18, likewise adjacent to one another. The detector device 19 is then accordingly designed to detect the adjacent single images 17 in the detection plane 18.

The detector device 19 is shown enlarged in FIG. 2. It consists of an optical fiber bundle 20 which feeds a detector array 24. The optical fiber bundle 20 is built up of individual optical fibers 21. The ends of the optical fibers 21 form the optical fiber bundle input 22, which lies in the detection plane 18. The individual ends of the optical fibers 21 therefore constitute pixels by means of which the diffraction-limited image 17 of the spot 14 is captured. Because the spot 14 in the embodiment in FIG. 1 is, by way of example, a point spot, the image 17 is an Airy disk, the size of which remains inside the circle which represents the detection plane 18 in FIGS. 1 and 2. The size of the optical fiber bundle input 22 is therefore such that the size of the Airy disk is covered thereby. The individual optical fibers 21 in the optical fiber bundle 20 are given a geometric arrangement at their outputs that is different from that at the optical fiber bundle input 22, particularly in the form of an extended plug 23, in which the output ends of the optical fibers 21 lie adjacent to one another. The plug 23 is designed to match the geometric arrangement of the detector row 24—i.e. each output end of an optical fiber 21 lies precisely in front of a pixel 25 of the detector row 24.

The geometric dimensions of the redistribution element are matched entirely fundamentally—meaning that they are matched on the input side thereof to the dimensions of the single image (and/or, in the case of multiple point-spots, to the adjacent single images), regardless of the implementation of the redistribution element, which is made in FIG. 4 by an optical fiber bundle. The redistribution element has the function of capturing the radiation from the detection plane 18 in such a manner that the intensity distribution of the single image 17, measured by the sampling theorem, is oversampled with respect to the diffraction limit. The redistribution element therefore has pixels (formed by the input ends of the optical fibers in the construction shown in FIG. 3) lying in the detection plane 18, which are smaller by at least a factor of 2 than the smallest resolvable structure produced in the detection plane 18 from the diffraction limit, taking into account the imaging scale.

Of course, the use of a plug 23 is only one of many possibilities for arranging the output ends of the optical fibers 21 in front of the pixels 25. It is equally possible to use other connections. In addition, the individual pixels 25 may be directly fused to the optical fibers 21. It is not at all necessary to use a detector row 24. Rather, an individual detector may be used for each pixel 25.

FIGS. 3 and 4 show possible embodiments of the optical fiber bundle input 22. The optical fibers 21 may be fused together at the optical fiber bundle input 22. In this way, a higher fullness factor is achieved, meaning that holes between the individual optical fibers 21 at the optical fiber bundle input 22 are minimized. The fusing would also lead to a certain crosstalk between adjacent optical fibers. If it is desired to prevent this, the optical fibers may be glued. A square arrangement of the ends of the optical fibers 21 is also possible, as FIG. 4 shows.

The individual optical fibers 21 are preferably assigned to the individual pixels 25 of the detector array 24 in such a way that the optical fibers 21 positioned adjacent to one another at the optical fiber bundle input 22 are also adjacent at the detector array 24. By means of this approach, crosstalk in minimized between adjacent pixels 25, whereby the said crosstalk may arise, by way of example, from scatter radiation or during the signal processing of the individual pixels 25. If the detector array 24 is a row, the corresponding arrangement may be achieved by fixing the sequence of the individual optical fibers on the detector row using a spiral which connects the individual optical fibers one after the other in the perspective of a top view of the detection plane 18.

FIG. 3 further shows blind fibers 26 which lie in the corners of the arrangement of the optical fibers 21 at the optical fiber bundle input 22. These blind fibers are not routed to pixels 25 of the detector array. There would no longer be any signal intensity required for the evaluation of the signals at the positions of the blind fibers. As a result, one may reduce the number of the optical fibers 21, and therefore the number of the pixels 25 in the detector row 24 or the detector array, in such a way that it is possible to work with 32 pixels, by way of example. Such detector rows 24 are already used in other ways in laser scanning microscopy, with the advantage that only one signal-evaluation electronic unit needs to be installed in such laser scanning microscopes, and a switch is then made between an existing detector row 24 and the further detector row 24 which is supplemented by the detector device 19.

According to FIG. 4, optical fibers with a square base shape are used for the bundle. They likewise have a high degree of coverage in the detection plane, and therefore efficiently collect the radiation.

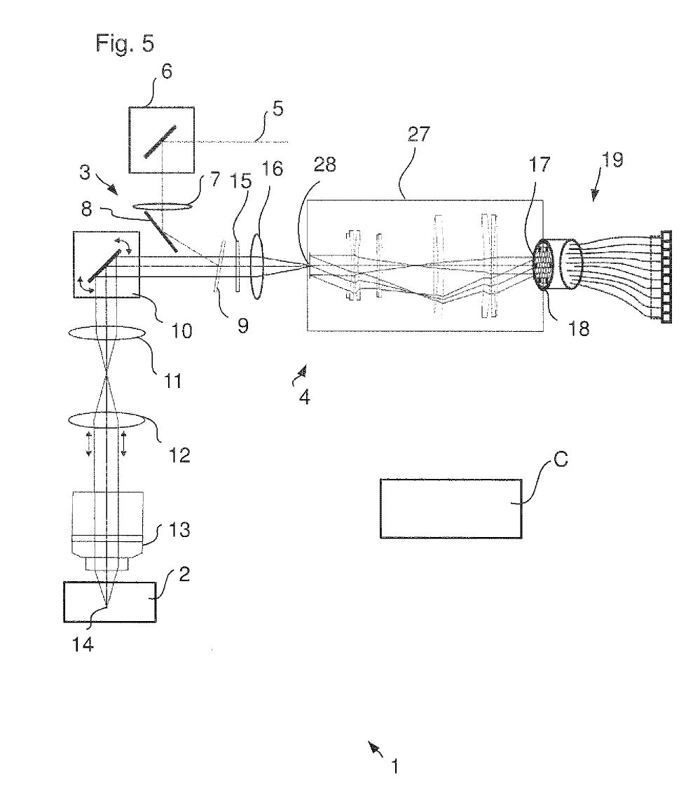

FIG. 5 shows one implementation of the LSM 1 in FIG. 1, whereby a zoom lens 27 is arranged in front of the detection plane 18. The conjugated plane in which the detection plane 18 was arranged in the construction shown in FIG. 1 now forms an intermediate plane 28 from which the zoom lens 27 captures the radiation and relays the same to the detection plane 18. The zoom lens 27 makes it possible for the image 17 to be optimally matched to the dimensions of the input of the detector device 19.

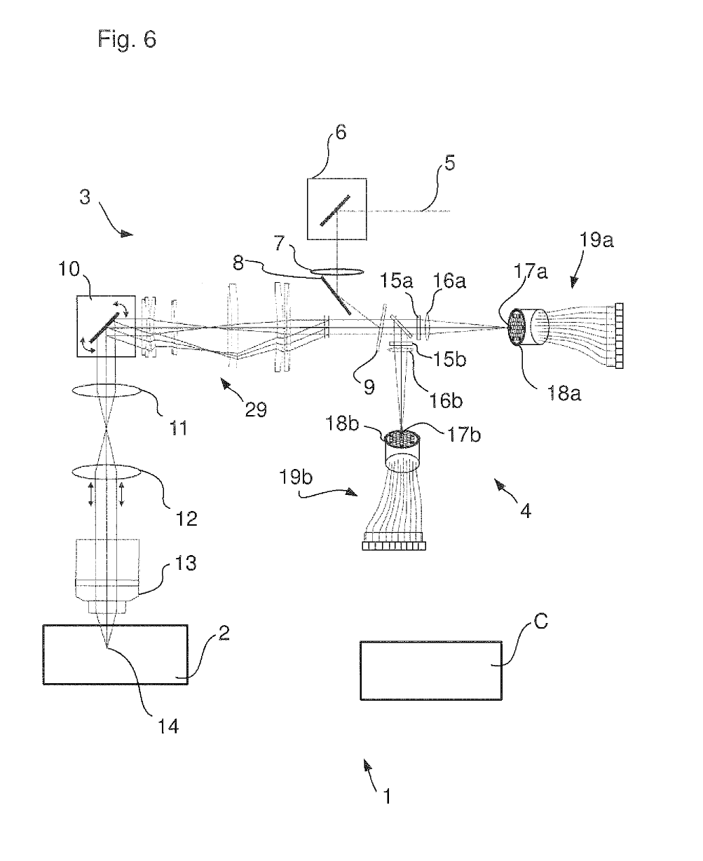

FIG. 6 shows yet another modification of the laser scanning microscope 1 in FIG. 1. On the one hand, the zoom lens is arranged in this case as the zoom lens 29 in such a way that it lies in a part of the beam path, the same being the route of both the illumination beam path 3 and the imaging beam path 4. As a result, there is the additional advantage that not only the size of the image 17 on the input side of the detector device 19 may be adapted, but also that the aperture fullness of the objective lens 13, relative to the imaging beam path 4, and therefore the utilization of the laser beam 5, may be adapted as well.

In addition, the LSM 1 in FIG. 6 also has a two-channel design, as a result of the fact that a beam splitter is arranged downstream of the emission filter 9 to separate the radiation into two separate color channels. The corresponding elements of the color channels each correspond to the elements that are arranged downstream of the emission filter 9 in the imaging direction in the LSM 1 in FIG. 1. The color channels are differentiated in the illustration in FIG. 6 by the reference number suffixes “a” and “b.”

Of course, the implementation using two color channels is independent of the use of the zoom lens 29. However, the combination has the advantage that a zoom lens 27 that would need to be independently included in each of the color channels and would, therefore, be present twice, is only necessary once. However, the zoom lens 27 may also, of course, be used in the construction according to FIG. 1, while the LSM 1 in FIG. 6 may also be realized without the zoom lens 29.

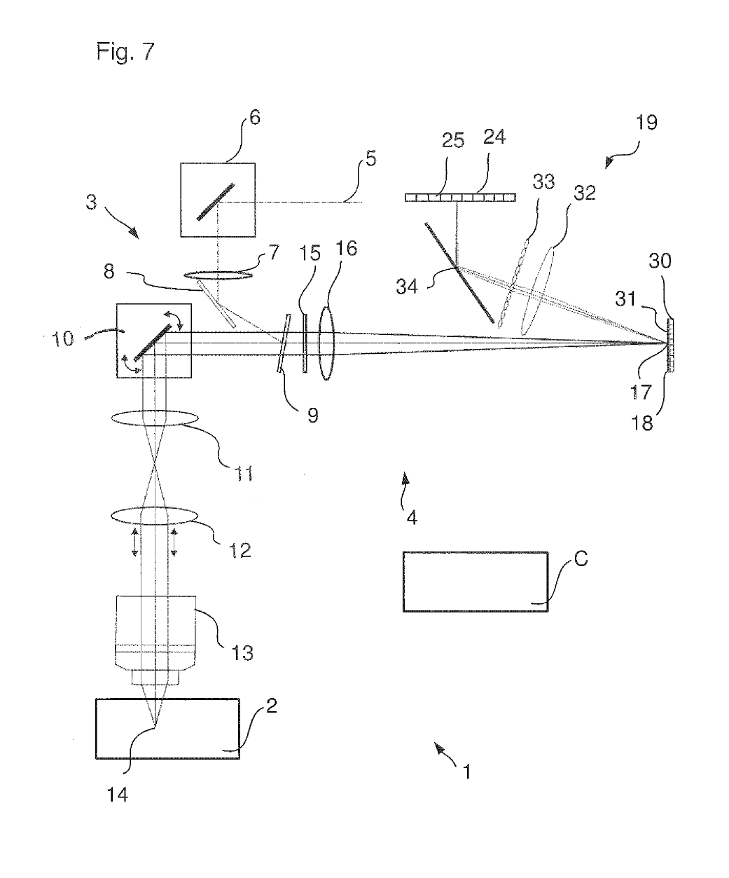

FIG. 7 shows a modification of the LSM 1 in FIG. 1, with respect to the detector device 19.

The detector device 19 now has a multi-facet mirror 30 carrying individual facets 31. The facets 31 correspond to the ends of the optical fibers 21 at the optical fiber bundle input 22 with respect to the resolution of the image 17. The individual facets 31 differ with respect to their inclination from the optical axis of the incident beam. Together with a lens 32 and a mini-lens array 33, as well as a deflector mirror 34 that only serves the purpose of beam folding, each facet 31 reproduces a surface area segment of the single image 17 on one pixel 25 of a detector array 24. Depending on the orientation of the facets 31, the detector array 24 in this case may preferably be a 2D array. However, a detector row is also possible.

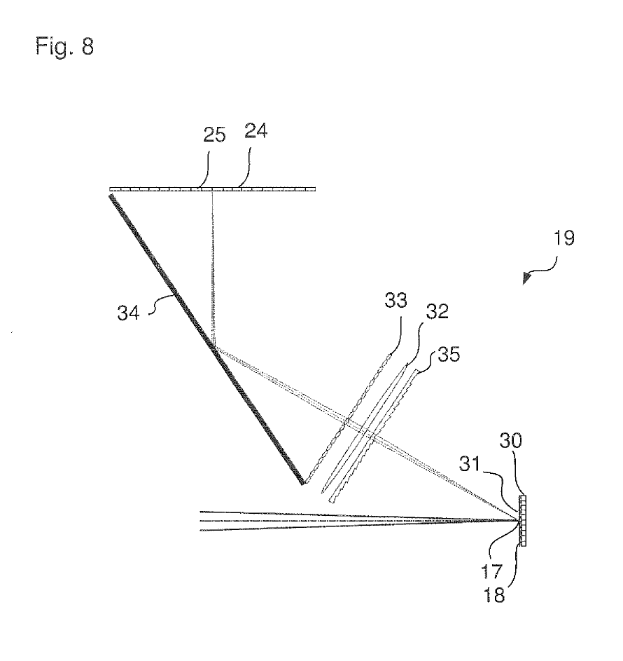

FIG. 8 shows one implementation of the detector device 19 in FIG. 7, whereby a refractive element 35 is still arranged in front of the lens 32, and distributes the radiation particularly well to a detector row.

The detector array 24 may, as already mentioned, be selected based on its geometry, with no further limitations. Of course, the redistribution element in the detector device 19 must then be matched to the corresponding detector array. The size of the individual pixels with which the image 17 is resolved is also no longer pre-specified by the detector array 24, but rather by the element which produces the redistribution of the radiation from the detection plane 18. For an Airy disk, the diameter of the disk in a diffraction-limited image is given by the formula 1.22·λ/NA, whereby λ is the average wavelength of the imaged radiation, and NA is the numerical aperture of the objective lens 13. The full width at half maximum is then 0.15·λ/NA. In order to achieve high resolution, it is sufficient for location accuracy of the detection to be made twice as high as the full width at half maximum, meaning that the full width at half maximum is sampled twice. A facet element 31 and/or an end of an optical fiber 21 at the optical fiber bundle input 22 may therefore be, at most, half as large as the full width at half maximum of the diffraction-limited single image. This, of course, is true taking into account the imaging scale which the optics behind the objective lens 13 produces. In the simplest case, a 4×4 array of pixels in the detection plane 18 per full width at half maximum would thereby be more than adequate.

The zoom lens which was explained with reference to FIGS. 5 and 6, makes possible—in addition to a [size] adaptation in such a way that the diffraction distribution of the diffraction-limited image 17 of the spot 14 optimally fills out the input face of the detector device 19—a further operating mode, particularly if more than one Airy disk is imaged in the detection plane 18. In a measurement in which more than one Airy disk is imaged on the detector device 19, light from further depth planes of the sample 2 may be detected on the pixels of the detector device 19 that lie further outwards. During the processing of the image, additional signal strengths are obtained without negatively influencing the depth resolution of the LSM 1.

The zoom lens 27 and/or 29, therefore, makes it possible to choose a compromise between the signal-to-noise ratio of the image and the depth resolution.

When building an LSM according to the embodiments described above, a “fused or bonded multi-mode fiber array for the sub-Airy spatially resolved detection in microscopy” is used.

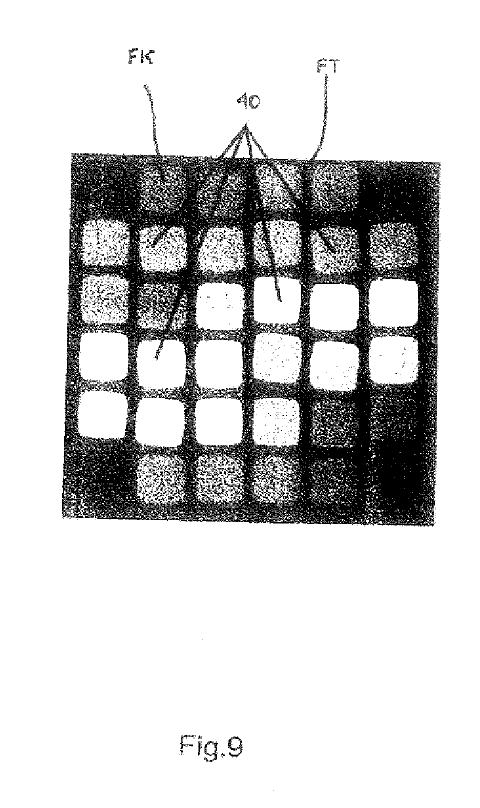

This arrangement has the two disadvantages shown in FIG. 9:

A distribution of fiber input faces 40 is shown there.

First, a loss of efficiency occurs because of the geometric fill factor between an effective surface FC (fiber core) and a dead zone FT around the fiber core (fiber cladding).

Secondly, there are mechanical inaccuracies in the exact positioning of the respective fiber cores in the fiber array, so that in reality, there is not an ideal uniform distribution or alignment of the fiber cores.

The aim of the invention is to provide a device which minimizes both of these problems. The invention is characterized by the features of the independent claims. Preferred embodiments are defined in the dependent claims.

The invention concerns the arrangement of a two-dimensional (not necessarily regular) array of optical elements in front of a fiber array to minimize the dead zones of the fibers and/or to change the geometry of the measuring ranges of the individual fibers.

This array can be much more geometrically accurate than the position of the individual fibers can be controlled, so that a higher precision of the measurement with the SR-LSM becomes possible.

In this case, the numerical aperture (NA) of the incident light should be much smaller than the NA of the fiber, as otherwise it may cause angles of light beams incident to the fiber which are too large due to the deflection of light from the dead zones.

The array can be used as a light funnel, with straight walls, with parabolic walls, or with mirrored walls. It may comprise a prism line of glass or plastic (PMMA), or it may consist of lenses (glass or plastic).

Production of the array may be effected by means of lithographic techniques (micro-optics).

By changing the geometry of the various areas, the geometric shape or size of the receiving areas of the various fibers may be arranged individually. The region through which the light is passed should be smaller than the sensitive surface of the fiber. This allows unwanted lateral displacements of individual fibers (manufacturing tolerances) of the fiber bundle to be at least partially compensated.

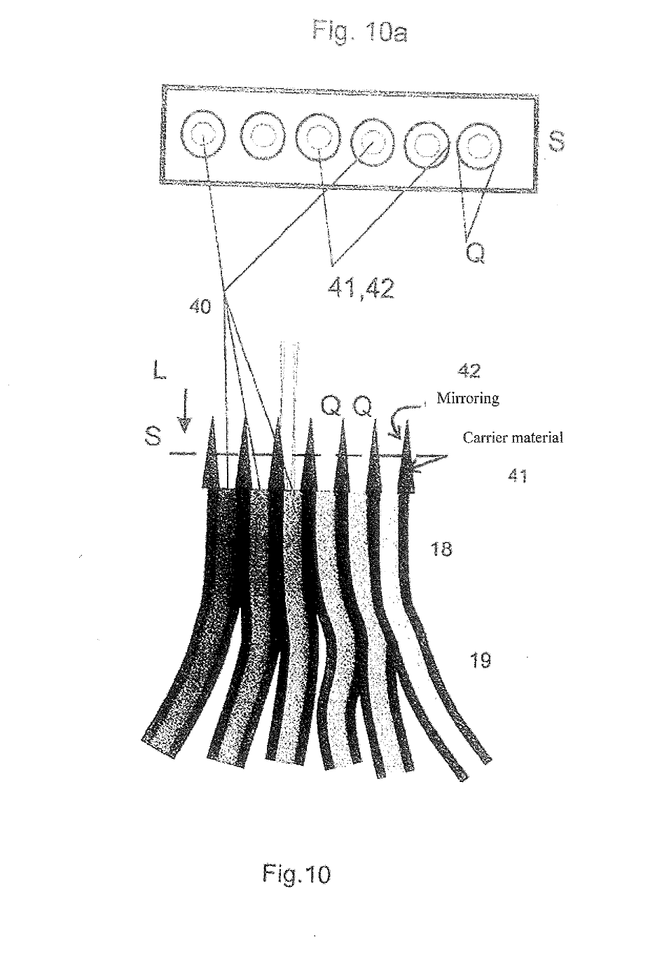

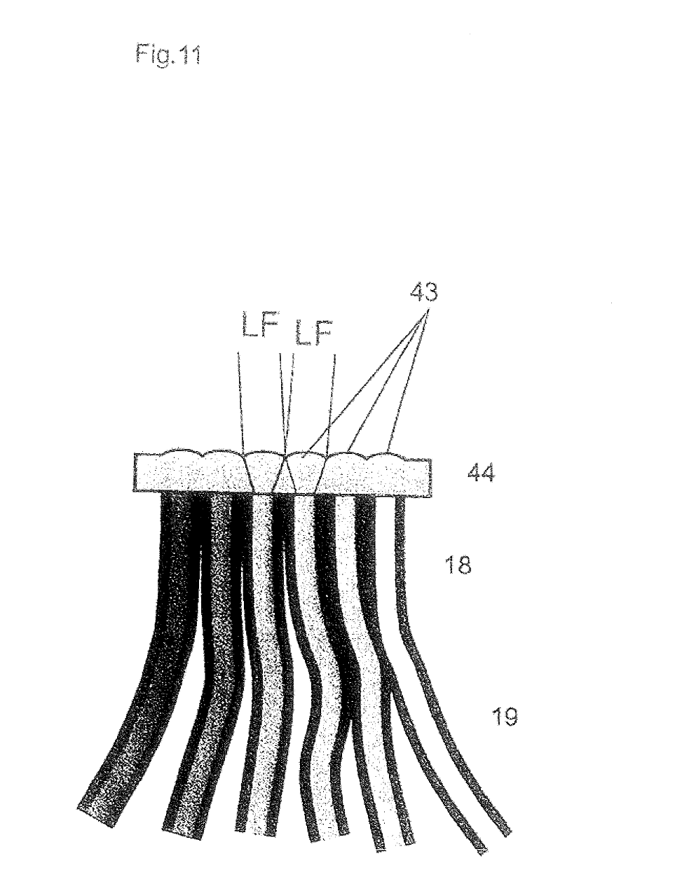

The invention is further illustrated by the FIGS. 10-14. The reference numerals in FIG. 9-14 mean:
FC: fiber core
FT: dead zone
40: input face
41: carrier
42: reflective coating
43: single lens
44: lens array
45: attachment
46: mid-range
47: chamfered area
48: intermediate image plane
49.1, 2, 3: light beam bundles
50: lens array
51: internal geometry
52: external geometry
E: light input faces

An array of light influencing elements according to the invention is dimensioned according to the invention such that incident light is concentrated or focused in an area that is preferably smaller than the core of the active optical fiber, thereby enabling differences in the positioning and sizes of single fibers to be compensated.

The numerical aperture (NA) of the light incident on the fiber array is much smaller than the NA of the individual fibers of the array. Therefore, the angle of the incident light may be increased without the increasing NA preventing the light from being received by the fiber.

By means of suitable mirrored “light funnels” (compound parabolic concentrator), light from the described dead zones may be imaged on the actual fiber core. The principle is shown (for a one-dimensional fiber array) in FIG. 10.

In FIG. 10, “light funnels” are arranged in the direction of light L upstream of the fiber input faces 40, which consist of mirror-coated wedge-shaped elements consisting of a carrier 41 and reflective coating 42 and which taper conically in the direction of the light, and thereby have an enlarged light incident surface with respect to the fiber surfaces at a distance from the faces 40 opposite to the light direction L.

This ensures all of the light reaching the cross-sections enters a fiber input face 40. This is also ensured through the mirrored side surfaces of the above-mentioned “light funnel.”

A schematic cross-section taken along a surface S in FIG. 1 in the light direction is shown in FIG. 1a.

The dead zone is significantly reduced only once through this light funnel. If, in addition, the lower (smaller) output port of the funnel is chosen to be smaller than the active core of the optical fiber, then slight mechanical displacements of individual fibers with respect to one another (tolerances in the manufacture of the fiber bundle) are no longer disturbing, as long as the light funnel array is formed with sufficient precision. This may be effected easily through lithographic methods (micro-optics).

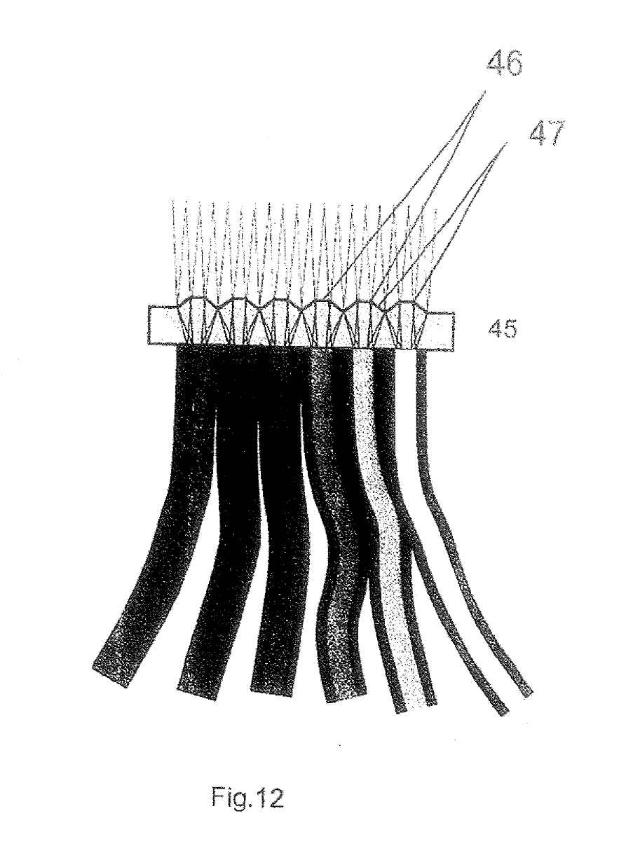

In FIG. 11, the fiber is arranged upstream of a mounted glass block with a lens array 44 consisting of concave single lenses 43, whereby each individual lens focuses all the incident light LF along its light opening face in an optical fiber input face 40.

Ideally, the array 44 is equally sized such that the area on which the light is concentrated in turn is smaller than the active core of a fiber in order to be equal and compensate for possible positioning errors of the individual fibers. In this way, no light energy is lost and all the light is transported to the fiber input faces.

In FIG. 12, chamfered light input faces 46, 47 of an attachment 45 are provided, so that the light passes undeflected respectively in a central region 46 in the direction of the fiber, while the light is refracted in the direction of the respective fiber input face in tapered portions 57. Advantageously here also, almost the entire light cross-section of each element 46, 47 passes into the interior of the fiber.

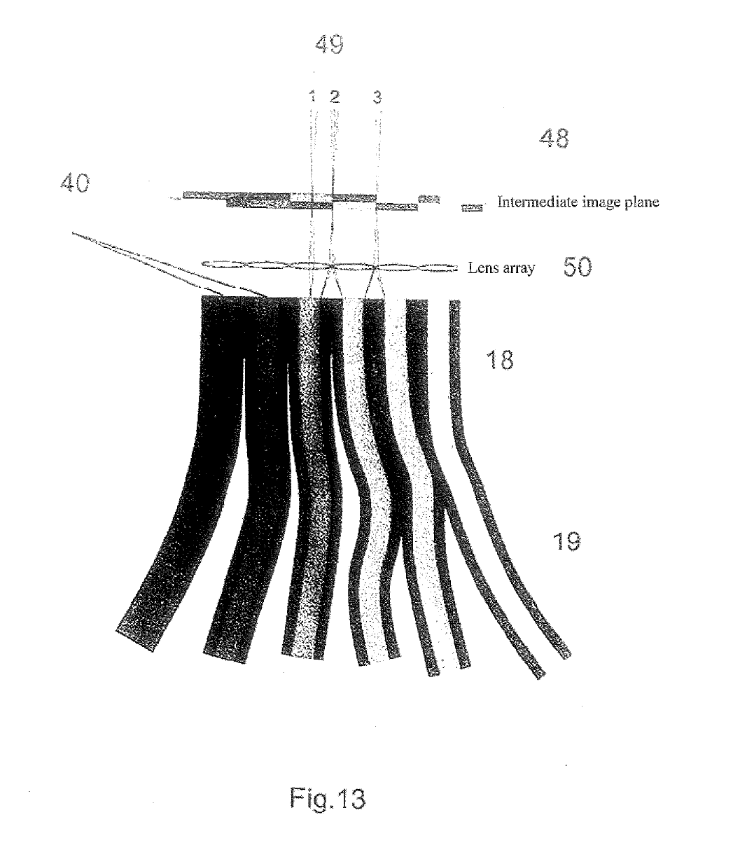

A further possibility is to display each individual fiber (including the associated dead region) enlarged in an intermediate image plane 48 that is optically conjugated with the sample plane so that the respective sensitive areas touch one another at the edges. This is shown in FIG. 13, in which a lens array 50, consisting of, for example, holographically-produced single lenses, is upstream of the optical fiber inputs 40, while the plane of the optical fiber inputs enlarged in the intermediate image plane 48 is imaged.

Single beams bundles 49.1, 2, 3 are shown in an intermediate image plane 48.

The bundle 49.1 passes through the cylindrical lens center without significant deflection, while the bundles 49.2 and 49.3 in the border areas of the respective cylindrical lenses are deflected towards each respective fiber bundle.

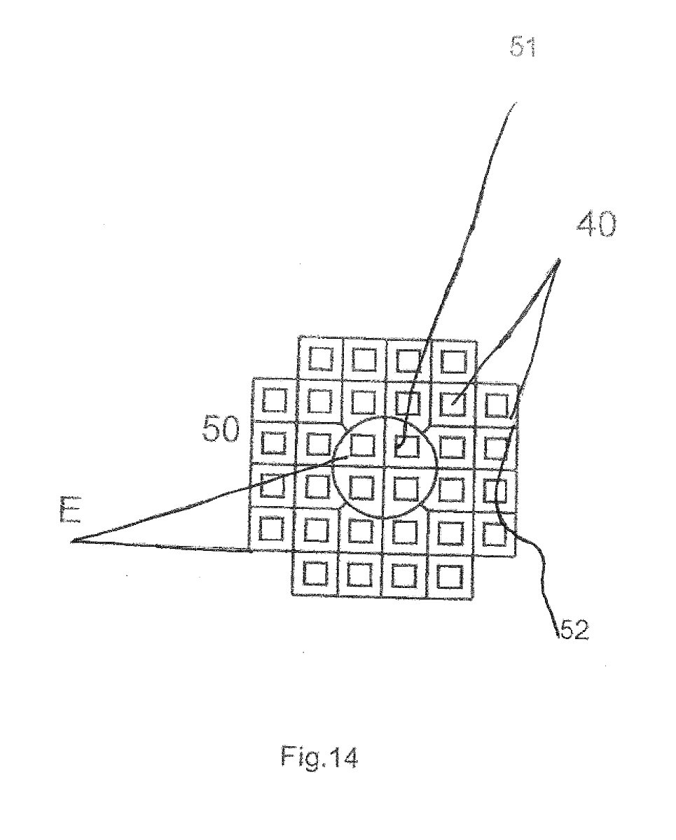

An important aspect of the invention is that (to a limited extent) the assignment of the sensitive area to the individual fibers may be made relatively simply as a result of the square arrangement of the differing geometries, as is indicated for example in FIG. 14.

FIG. 14 shows the principle of an assignment of the areas which deviates from the regular square array.

In principle, the lithographic manufacturing process allows the formation of any area limits. The limiting factor here is simply that the deflection angle of the range limits towards the core of the glass fiber must not be greater than the receiving angle of the glass fiber.

Variously shaped light input faces E of an optical attachment OA upstream of the fiber bundle are shown schematically with the input faces 40.

In this case, each area of the attachment is assigned to one or more light input ports.

This involves rectangular or square or hexagonal input faces, whereby in an internal round geometry 51 with respect to an external rectangular geometry 52, different-sized and different-shaped light input faces guide the light in each of the individual fibers 40.

For example, a circular pinhole is simulated here through the internal geometry 51 the optical fibers of which may be read by the detector elements separately from the fibers of the external geometry 52.

In addition, several concentric circles of individual elements which are read separately by the detector elements are conceivable here.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A microscope for high resolution scanning microscopy of a sample, comprising
an illumination device for the purpose of illuminating the sample,
an imaging device for the purpose of scanning at least one point or linear spot over the sample and of imaging the point or linear spot into a diffraction-limited, static single image, with an imaging scale in a detection plane,
a detector device for the purpose of detecting the single image in the detection plane for various scan positions, with a spatial resolution which, taking into account the imaging scale in at least one dimension/measurement, is at least twice as high as a full width at half maximum of the diffraction-limited single image,
an evaluation device for the purpose of evaluating a diffraction structure of the single image for the scan positions, using data from the detector device, and for the purpose of generating an image of the sample which has a resolution which is enhanced beyond the diffraction limit, said detector device having a detector array which has pixels and which is larger than the single image, and a non-imaging redistribution element which is arranged in front of the detector array and which distributes the radiation from the detection plane onto the pixels of the detector array in a non-imaging manner.

2. The microscope according to claim 1, wherein said redistribution element comprises a bundle of optical fibers, preferably of multi-mode optical fibers, which has an input arranged in the detection plane, and an output where the optical fibers end at the pixels of the detector array in a geometric arrangement which differs from that of the input.

3. The microscope according to claim 2, wherein said optical fibers run from the input to the output in such a manner that optical fibers which are adjacent the output are also adjacent the input in order to minimize a radiation intensity-dependent crosstalk between adjacent pixels.

4. The microscope according to claim 1, wherein said redistribution element has a mirror with differently inclined mirror elements, particularly a multi-facet mirror, a DMD, or an adaptive mirror, which deflects radiation from the detection plane onto the pixels of the detector array, whereby the pixels of the detector array have a geometric arrangement which differs from that of the mirror elements.

5. The microscope according to claim 1, wherein said imaging device has a zoom lens arranged in front of the detection plane in the imaging direction, for the purpose of matching the size of the single image to that of the detector device.

6. The microscope according to claim 5, wherein said illumination device and the imaging device share a scanning device such that the illumination device illuminates the sample with a diffraction-limited point or linear spot which coincides with the spot imaged by the imaging device, whereby the zoom lens is arranged in such a manner that it is also a component of the illumination device.

7. The microscope according to claim 1, wherein said detector array is a detector row.

8. A method for high resolution scanning microscopy of a sample, comprising
illuminating said sample;
guiding at least one point or linear spot over the sample in a scanning manner so that it is imaged into a single image, wherein the spot is imaged into the single image, with an imaging scale, and diffraction-limited, and the single image is static in a detection plane;
detecting the single image for various scan positions with a location accuracy which is at least twice as high, taking into account the imaging scale, as a full width at half maximum of the diffraction-limited single image, such that a diffraction structure of the single image is detected;
evaluating the diffraction structure of the single image for each scan position, and generating an image of the sample which has a resolution which is enhanced beyond the diffraction limit;
a detector array being included which comprises the pixels and is larger than the single image; and
radiation of the single image from the detection plane being redistributed on the pixels of the detector array in a non-imaging manner.

9. The method according to claim 8, wherein said radiation of the single image is redistributed by means of a bundle of multi-mode optical fibers, which has an input arranged in the detection plane, and an output where the optical fibers end at the pixels of the detector array in a geometric arrangement which differs from that of the input.

10. The method according to claim 9, wherein said optical fibers run from the input to the output in such a manner that optical fibers which are adjacent at the output are also adjacent at the input, in order to minimize a radiation intensity-dependent crosstalk between adjacent pixels.

11. The method according to claim 8, wherein said bundle of optical fibers and the detector array are calibrated, by each optical fiber individually receiving radiation, by interference signals in pixels which are associated with optical fibers which are adjacent thereto at the output being detected, and by a calibration matrix being established, by means of which a radiation intensity-dependent crosstalk between adjacent pixels is corrected in the subsequent microscopy of the sample.

12. The method according to claim 8, wherein said radiation of the single image is redistributed by means of a mirror with differently inclined mirror elements, wherein the radiation from the detection plane is directed by the mirror onto the pixels of the detector array, and whereby the pixels of the detector array have a geometric arrangement which differs from that of the mirror elements.

13. The method according to claim 8, wherein said detector row is used as the detector array.

14. The method according to claim 8, further comprising determining a direction of movement of the scanning of the point or linear spot by signals of individual pixels of the detector array being evaluated by means of cross-correlation.

15. The method according to claim 8, further comprising detecting changes in the sample by means of determining and evaluating a chronological change in the diffraction-limited single image for the point or linear spot which is static in the sample.

16. The microscope according to claim 2, wherein the bundle of optical fibers in a light direction are provided upstream of elements influencing the light direction to assign the detection light to light input ports of the individual optical fibers.

17. The microscope according to claim 16, wherein mirrored elements are arranged upstream of the individual optical fibers.

18. The microscope according to claim 16, wherein an element is arranged upstream of each individual optical fiber that transmits light in a direction of the detector array.

19. The microscope according to claim 16, wherein said elements have a decreasing cross-section in the direction of the light.

20. The microscope according to claim 16, wherein said elements are tube-shaped.

21. The microscope according to claim 20, wherein said tube-shaped elements are funnel shaped.

22. The microscope according to claim 16, wherein a lower cross-section of said elements is smaller than the diameter of the optically-active fiber core of the individual optical fibers.

23. The microscope according to claim 16, wherein refractive elements are assigned to the individual optical fibers.

24. The microscope according to claim 23, wherein said refractive elements have at least one curvature that bundles the light in a direction of light input ports.

25. The microscope according to claim 16, further comprising a convex lens and/or piano-convex lens for light bundling.

26. The microscope according to claim 23, wherein said refractive elements are prism structures that are optically assigned to the individual optical fibers.

27. The microscope according to claim 26, wherein said prism structures have a central area perpendicular to the light and edge areas at an angle to the direction of light not equaling 90 degrees in order to influence the direction of the light.

28. The microscope according to claim 16, wherein at least a portion of the individual fibers are optically assigned to lenses of a lens array.

29. The microscope according to claim 27, wherein said lens array for imaging the light input faces in an intermediate image plane that is optically conjugate to the sample plane is arranged between an intermediate image plane and the plane of the light input faces.

30. The microscope according to claim 23, wherein said refractive elements cause a bundling of the light in an area, the diameter of which is less than the optically effective diameter of light input openings of the individual fibers or the fiber core.

31. The microscope according to claim 16, wherein said elements influencing the direction of light occurs in different geometric distributions.

32. The microscope according to claim 16, wherein at least one element of said elements impinges at least one input opening of the fiber bundle.

33. The microscope according to claim 16, wherein a light-permeable component is arranged upstream of the fiber bundle and has multiple different geometric distributions of the elements.

34. The microscope according to claim 32, wherein the individual elements for impinging a different number of fiber input openings have a different size.

35. The microscope according to claim 16, wherein at least one geometric circular structure of elements is provided.

36. The method according to claim 8, wherein the bundle of optical fibers in a light direction are provided upstream of elements influencing the light direction to assign the detection light to light input ports of the individual optical fibers.

37. The method according to claim 36, wherein mirrored elements are arranged upstream of the individual optical fibers.

38. The method according to claim 36, wherein an element is arranged upstream of each individual optical fiber that transmits light in a direction of the detector array.

39. The method according to claim 36, wherein said elements have a decreasing cross-section in the direction of the light.

40. The method according to claim 36, wherein said elements are tube-shaped.

41. The method according to claim 40, wherein said tube-shaped elements are funnel shaped.

42. The method according to claim 36, wherein a lower cross-section of said elements is smaller than the diameter of the optically-active fiber core of the individual optical fibers.

43. The method according to claim 36, wherein refractive elements are assigned to the individual optical fibers.

44. The method according to claim 43, wherein said refractive elements have at least one curvature that bundles the light in a direction of light input ports.

45. The method according to claim 36, further comprising a convex lens and/or plano-convex lens for light bundling.

46. The method according to claim 43, wherein said refractive elements are prism structures that are optically assigned to the individual optical fibers.

47. The method according to claim 46, wherein said prism structures have a central area perpendicular to the light and edge areas at an angle to the direction of light not equaling 90 degrees in order to influence the direction of the light.

48. The method according to claim 36, wherein at least a portion of the individual fibers are optically assigned to lenses of a lens array.

49. The method according to claim 47, wherein said lens array for imaging the light input faces in an intermediate image plane that is optically conjugate to the sample plane is arranged between an intermediate image plane and the plane of the light input faces.

50. The method according to claim 43, wherein said refractive elements cause a bundling of the light in an area, the diameter of which is less than the optically effective diameter of light input openings of the individual fibers or the fiber core.

51. The method according to claim 36, wherein said elements influencing the direction of light occurs in different geometric distributions.

52. The method according to claim 36, wherein at least one element of said elements impinges at least one input opening of the fiber bundle.

53. The method according to claim 36, wherein a light-permeable component is arranged upstream of the fiber bundle and has multiple different geometric distributions of the elements.

54. The method according to claim 53, wherein the individual elements for impinging a different number of fiber input openings have a different size.

55. The method according to claim 36, wherein at least one geometric circular structure of elements is provided.

56. The microscope according to claim 7, wherein said detector row is an APD row.

57. The microscope according to claim 7, wherein said detector row is an PMT row.

58. The method according to claim 12, wherein said mirror is a multifacet mirror.

59. The method according to claim 12, wherein said mirror is a DMD.

60. The method according to claim 12, wherein said mirror is an adaptive mirror.

61. The method according to claim 13, wherein said detector row is an APD.

62. The method according to claim 13, wherein said detector row is a PMT row.
